(19) United States
(12) Patent Application Publication
(10) Pub. No.: US 2026/0066977 A1
(43) Pub. Date: Mar. 5, 2026

(54) ACTIVE BANDWIDTH PART FOR BEAM APPLICATION TIME IN UNIFIED TRANSMISSION CONFIGURATION INDICATION FRAMEWORK

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 19/106,859

(22) PCT Filed: Oct. 19, 2022
(86) PCT No.: PCT/CN2022/126087

§ 371 Date: Feb. 26, 2025

(51) Int. Cl. H04B 7/06; H04L 27/26; H04W 72/232

(52) U.S. Cl. CPC H04B 7/06952; H04L 27/26025; H04W 72/232

(57) ABSTRACT

Various aspects of the present disclosure generally relate to wireless communication. In some aspects, a user equipment (UE) may receive, from a network node, a downlink control information (DCI) message that carries a transmission configuration indication (TCI) state indication. The UE may apply the TCI state indication after a beam application time that is based at least in part on an active bandwidth part associated with the TCI state indication. The UE may communicate with the network node using a beam associated with the TCI state indication after the TCI state indication is applied. Numerous other aspects are described.

### FIELD OF THE DISCLOSURE

Aspects of the present disclosure generally relate to wireless communication and to techniques and apparatuses associated with an active bandwidth part (BWP) for a beam application time in a unified transmission configuration indication (TCI) framework.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive, from a network node, a downlink control information (DCI) message that carries a transmission configuration indication (TCI) state indication. The one or more processors may be configured to apply the TCI state indication after a beam application time that is based at least in part on an active bandwidth part associated with the TCI state indication. The one or more processors may be configured to communicate with the network node using a beam associated with the TCI state indication after the TCI state indication is applied.

Some aspects described herein relate to a method of wireless communication performed by a UE. The method may include receiving, from a network node, a DCI message that carries a TCI state indication. The method may include applying the TCI state indication after a beam application time that is based at least in part on an active bandwidth part associated with the TCI state indication. The method may include communicating with the network node using a beam associated with the TCI state indication after the TCI state indication is applied.

Some aspects described herein relate to a non-transitory computer-readable medium that stores a set of instructions for wireless communication by a UE. The set of instructions, when executed by one or more processors of the UE, may cause the UE to receive, from a network node, a DCI message that carries a TCI state indication. The set of instructions, when executed by one or more processors of the UE, may cause the UE to apply the TCI state indication after a beam application time that is based at least in part on an active bandwidth part associated with the TCI state indication. The set of instructions, when executed by one or more processors of the UE, may cause the UE to communicate with the network node using a beam associated with the TCI state indication after the TCI state indication is applied.

Some aspects described herein relate to an apparatus for wireless communication. The apparatus may include means for receiving, from a network node, a DCI message that carries a TCI state indication. The apparatus may include means for applying the TCI state indication after a beam application time that is based at least in part on an active bandwidth part associated with the TCI state indication. The apparatus may include means for communicating with the network node using a beam associated with the TCI state indication after the TCI state indication is applied.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of using beams for access link communications between a network node and a UE, in accordance with the present disclosure.

FIG. 4 is a diagram illustrating an example associated with an active bandwidth part (BWP) for a beam application time in a unified transmission configuration indication (TCI) framework, in accordance with the present disclosure.

FIG. 5 is a diagram illustrating an example process associated with an active BWP for a beam application time in a unified TCI framework, in accordance with the present disclosure.

FIG. 6 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

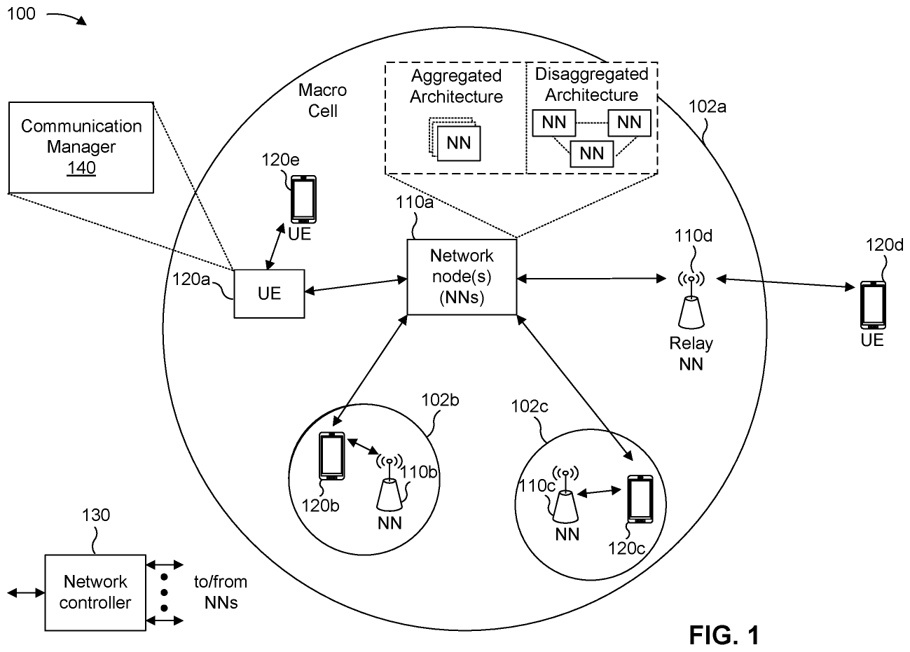

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node 110, a downlink control information (DCI) message that carries a transmission configuration indication (TCI) state indication; apply the TCI state indication after a beam application time that is based at least in part on an active bandwidth part associated with the TCI state indication; and communicate with the network node 110 using a beam associated with the TCI state indication after the TCI state indication is applied. Additionally, or alternatively, the communication manager 140 may perform one or more other operations described herein.

As indicated above, FIG. 1 is provided as an example. Other examples may differ from what is described with regard to FIG. 1.

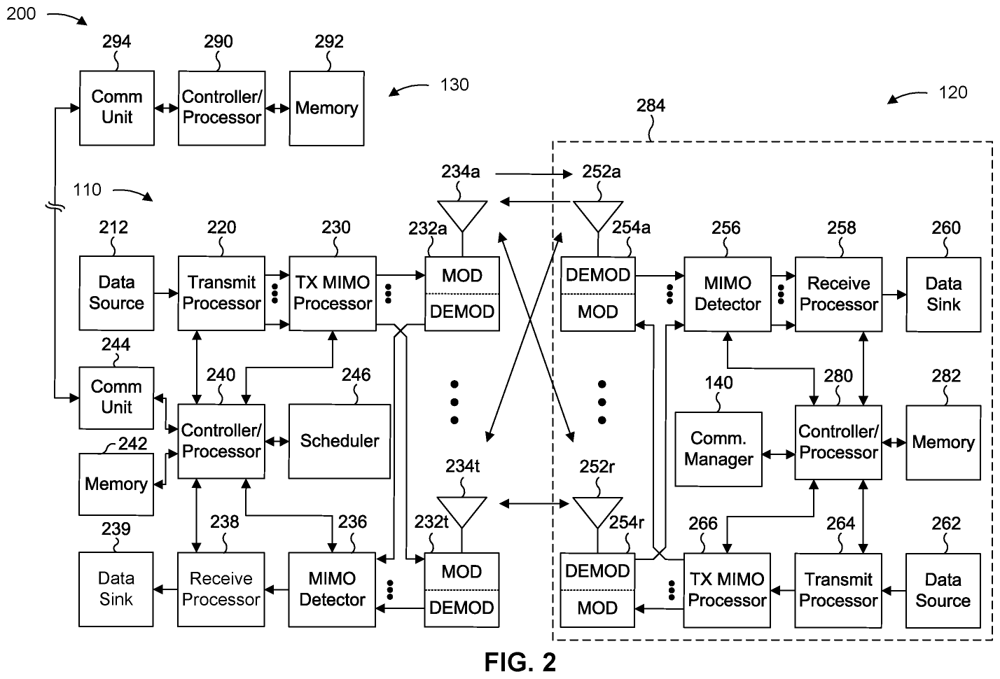

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

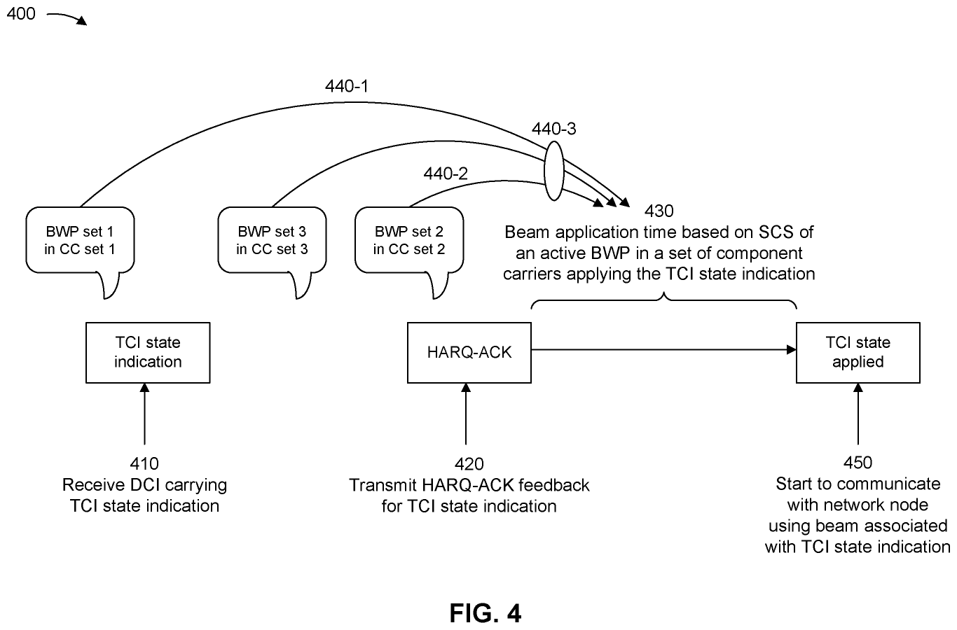

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-6).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-6).

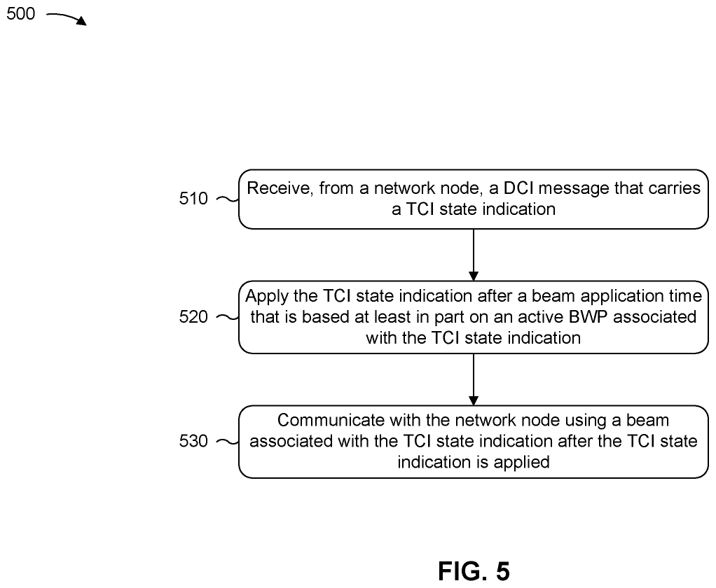

The controller/processor 240 of the network node 110, the controller/processor 280 of the UE 120, and/or any other component(s) of FIG. 2 may perform one or more techniques associated with an active bandwidth part (BWP) for a beam application time in a unified TCI framework, as described in more detail elsewhere herein. For example, the controller/processor 240 of the network node 110, the controller/processor 280 of the UE 120, and/or any other component(s) of FIG. 2 may perform or direct operations of, for example, process 500 of FIG. 5 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 500 of FIG. 5 and/or other processes as described herein. In some examples, executing instructions may include running the instructions, converting the instructions, compiling the instructions, and/or interpreting the instructions, among other examples.

In some aspects, the UE 120 includes means for receiving, from a network node 110, a DCI message that carries a TCI state indication; means for applying the TCI state indication after a beam application time that is based at least in part on an active bandwidth part associated with the TCI state indication; and/or means for communicating with the network node 110 using a beam associated with the TCI state indication after the TCI state indication is applied. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, the DU, and the RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

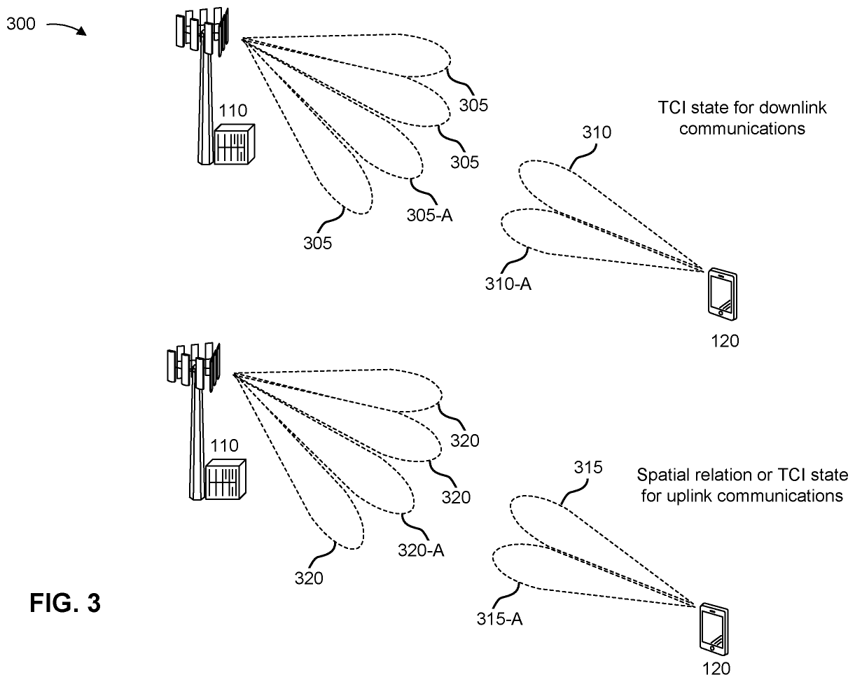

FIG. 3 is a diagram illustrating an example 500 of using beams for access link communications between a network node and a UE, in accordance with the present disclosure. As shown in FIG. 3, a network node 110 and a UE 120 may communicate with one another in a wireless network (e.g., wireless network 100).

The network node 110 may transmit to UEs 120 located within a coverage area of the network node 110. The network node 110 and the UE 120 may be configured for beamformed communications, where the network node 110 may transmit in the direction of the UE 120 using a directional downlink transmit beam, and the UE 120 may receive the transmission using a directional downlink receive beam. Each downlink transmit beam may have an associated beam ID, beam direction, or beam symbols, among other examples. The network node 110 may transmit downlink communications via one or more downlink transmit beams 305.

The UE 120 may attempt to receive downlink transmissions via one or more downlink receive beams 310, which may be configured using different beamforming parameters at receive circuitry of the UE 120. The UE 120 may identify a particular downlink transmit beam 305, shown as downlink transmit beam 305-A, and a particular downlink receive beam 310, shown as downlink receive beam 310-A, that provide relatively favorable performance (e.g., that have a best channel quality of the different measured combinations of downlink transmit beams 305 and downlink receive beams 310). In some examples, the UE 120 may transmit an indication of which downlink transmit beam 305 is identified by the UE 120 as a preferred downlink transmit beam, which the network node 110 may select for transmissions to the UE 120. The UE 120 may thus attain and maintain a beam pair link (BPL) with the network node 110 for downlink communications (e.g., a combination of the downlink transmit beam 305-A and the downlink receive beam 310-A), which may be further refined and maintained in accordance with one or more established beam refinement procedures.

A downlink beam, such as a downlink transmit beam 305 or a downlink receive beam 310, may be associated with a TCI state. A TCI state may indicate a directionality or a characteristic of the downlink beam, such as one or more quasi co-location (QCL) properties of the downlink beam. A QCL property may include, for example, a Doppler shift, a Doppler spread, an average delay, a delay spread, or spatial receive parameters, among other examples. In some examples, each downlink transmit beam 305 may be associated with a synchronization signal block (SSB), and the UE 120 may indicate a preferred downlink transmit beam 305 by transmitting uplink transmissions in resources of the SSB that are associated with the preferred downlink transmit beam 305. A particular SSB may have an associated TCI state (e.g., for an antenna port or for beamforming). The network node 110 may, in some examples, indicate a downlink transmit beam 305 based at least in part on antenna port QCL properties that may be indicated by the TCI state. A TCI state may be associated with one downlink reference signal set (e.g., an SSB and an aperiodic, periodic, or semi-persistent channel state information reference signal (CSI-RS)) for different QCL types (e.g., QCL types for different combinations of Doppler shift, Doppler spread, average delay, delay spread, or spatial receive parameters, among other examples). In cases where the QCL type indicates spatial receive parameters (e.g., QCL type D), the QCL type may correspond to analog receive beamforming parameters of a downlink receive beam 310 at the UE 120. Thus, the UE 120 may select a corresponding downlink receive beam 310 from a set of BPLs based at least in part on the network node 110 indicating a downlink transmit beam 305 via a TCI state indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a physical downlink shared channel (PDSCH). The set of activated TCI states for downlink control channel communications may correspond to beams that the network node 110 may use for downlink transmission on a physical downlink control channel (PDCCH) or in a control resource set (CORESET). The UE 120 may also maintain a set of activated TCI states for receiving the downlink shared channel transmissions and/or the downlink control channel transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (e.g., activated PDSCH TCI states and activated CORESET TCI states) for the UE 120 may be configured by a configuration message, such as a radio resource control (RRC) message (e.g., an RRCReconfiguration message).

Similarly, for uplink communications, the UE 120 may transmit in the direction of the network node 110 using a directional uplink transmit beam, and the network node 110 may receive the transmission using a directional uplink receive beam. Each uplink transmit beam may have an associated beam ID, beam direction, or beam symbols, among other examples. The UE 120 may transmit uplink communications via one or more uplink transmit beams 315.

The network node 110 may receive uplink transmissions via one or more uplink receive beams 320. The network node 110 may identify a particular uplink transmit beam 315, shown as uplink transmit beam 315-A, and a particular uplink receive beam 320, shown as uplink receive beam 320-A, that provide relatively favorable performance (e.g., that have a best channel quality of the different measured combinations of uplink transmit beams 315 and uplink receive beams 320). In some examples, the network node 110 may transmit an indication of which uplink transmit beam 315 is identified by the network node 110 as a preferred uplink transmit beam, which the network node 110 may select for transmissions from the UE 120. The UE 120 and the network node 110 may thus attain and maintain a BPL for uplink communications (e.g., a combination of the uplink transmit beam 315-A and the uplink receive beam 320-A), which may be further refined and maintained in accordance with one or more established beam refinement procedures. An uplink beam, such as a uplink transmit beam 315 or a uplink receive beam 320, may be associated with a spatial relation. A spatial relation may indicate a directionality or a characteristic of the uplink beam, similar to one or more QCL properties, as described above.

Additionally, or alternatively, as shown in FIG. 3, the network node 110 and the UE 120 may communicate using a unified TCI framework, in which case the network node 110 may indicate a TCI state that the UE 120 is to use for beamformed uplink communications. For example, in a unified TCI framework, a joint TCI state (which may be referred to as a joint downlink and uplink TCI state) may be used to indicate a common beam that the UE 120 is to use for downlink communication and uplink communication. In this case, the joint downlink and uplink TCI state may include at least one source reference signal to provide a reference (or UE assumption) for determining QCL properties for a downlink communication or a spatial filter for uplink communication. For example, the joint downlink and uplink TCI state may be associated with one or more source reference signals that provide common QCL information for UE-dedicated PDSCH reception and one or more CORESETs in a component carrier, or one or more source reference signals that provide a reference to determine one or more common uplink transmission spatial filters for a physical uplink shared channel (PUSCH) transmission based on a dynamic grant or a configured grant or one or more dedicated physical uplink control channel (PUCCH) resources in a component carrier.

Additionally, or alternatively, the unified TCI framework may support a separate downlink and uplink TCI states to accommodate separate downlink and uplink beam indications (e.g., in cases where a best uplink beam does not correspond to a best downlink beam, or vice versa). In such cases, each valid uplink TCI state may be associated with a source reference signal to indicate an uplink transmit beam for a target uplink communication (e.g., a target uplink reference signal or a target uplink channel). For example, the source reference signal may be an sounding reference signal (SRS), an SSB, or a CSI-RS, among other examples, and the target uplink communication may be a physical random access channel (PRACH), a PUCCH, a PUSCH, an SRS, and/or a DMRS (e.g., for a PUCCH or a PUSCH), among other examples. In this way, supporting joint TCI states or separate downlink and uplink TCI states may enable a unified TCI framework for downlink and uplink communications and/or may enable the network node 110 to indicate various uplink QCL relationships (e.g., Doppler shift, Doppler spread, average delay, or delay spread, among other examples) for uplink TCI communication.

In a wireless network that supports the unified TCI framework, a network node may transmit a DCI message that carries a TCI state indication to change a downlink beam, an uplink beam, and/or a joint downlink and uplink beam that a UE uses to communicate with the network node, and the UE may subsequently transmit hybrid automatic repeat request (HARQ) feedback to the network node to acknowledge the TCI state indication. In general, the UE may apply the TCI state indication starting from a first slot that is at least a configured number of symbols after a last symbol of an uplink transmission that carries the HARQ feedback. Accordingly, the configured number of symbols may generally define a beam application time that starts after the last symbol of the uplink transmission that carries the HARQ feedback and has a duration that depends on one or more active BWPs in one or more sets of component carriers applying the updated beam associated with the TCI state indication. For example, because the beam application time is based on a configured number of symbols, the duration of the beam application time may depend on a subcarrier spacing that defines a symbol duration for an active BWP. However, the component carrier(s) and/or active BWP(s) that a UE uses to communicate may change over a duration between a slot in which the UE receives the DCI message carrying the TCI state indication and a slot in which the UE transmits the HARQ feedback for the TCI state indication. As a result, there may be ambiguity regarding how the UE is to determine the component carrier(s) and/or active BWP(s) to use to determine the beam application time (e.g., potentially degrading access link performance if the UE were to apply the TCI state indication earlier or later than the network node). Accordingly, some aspects described herein relate to techniques to determine the component carrier(s) and/or active BWP(s) to be used to determine the beam application time for a TCI state indication associated with a unified TCI framework.

As indicated above, FIG. 3 is provided as an example. Other examples may differ from what is described with regard to FIG. 3.

FIG. 4 is a diagram illustrating an example 400 associated with an active BWP for a beam application time in a unified TCI framework, in accordance with the present disclosure. As described herein, example 400 includes communication between a network node (e.g., network node 110) and a UE (e.g., UE 120). In some aspects, the network node and the UE may communicate in a wireless network, such as wireless network 100. The network node and the UE may communicate via a wireless access link, which may include an uplink and a downlink.

As shown in FIG. 4, and by reference number 410, the network node may transmit, and the UE may receive, a DCI message that carries a TCI state indication.

For example, in some aspects, the TCI state indication may include a parameter (e.g., DLorJointTCIState) to indicate a downlink beam that the UE is to use to receive one or more downlink transmissions from the network node and/or a joint downlink and uplink beam that the UE is to use to receive one or more downlink transmissions from the network node and transmit one or more uplink transmissions to the network node. Additionally, or alternatively, the TCI state indication may include a parameter (e.g., UL-TCIState) to indicate an uplink beam that the UE is to use to transmit one or more uplink transmissions to the network node. In some aspects, the DCI message that carries the TCI state indication may be transmitted with a downlink assignment to schedule a PDSCH transmission to the UE, or the DCI message may be transmitted without a downlink assignment. Additionally, or alternatively, the DCI message may include an uplink grant that indicates a PUSCH resource for the UE.

As further shown in FIG. 4, and by reference number 420, the UE may transmit, and the network node may receive, an uplink transmission that carries HARQ feedback for the TCI state indication. For example, in cases where the DCI message that carries the TCI state indication does not include a downlink assignment (e.g., does not schedule a PDSCH transmission to the UE), the UE may transmit the HARQ feedback for the TCI state indication in a PUCCH transmission corresponding to the DCI message carrying the TCI state indication. Additionally, or alternatively, the UE may include the HARQ feedback for the TCI state indication in a PUSCH transmission corresponding to the DCI message carrying the TCI state indication (e.g., where the DCI message includes a downlink grant and the HARQ feedback is included in a PUSCH transmission if the PUSCH transmission overlaps with a PUCCH transmission to carry the HARQ feedback). Additionally, or alternatively, in cases where the DCI message carrying the TCI indication includes a downlink assignment, the UE may transmit the HARQ feedback for the TCI state indication in a PUCCH transmission or a PUSCH transmission that carries HARQ-ACK information corresponding to the PDSCH scheduled by the DCI message carrying the TCI state indication.

As further shown in FIG. 4, and by reference number 430, the UE may determine a beam application time based on a subcarrier spacing of an active BWP in a set of component carriers applying the TCI state indication. For example, in some aspects, the network node may configure a parameter (e.g., BeamAppTime_r17) that defines a number of symbols, Y, and the TCI state indication provided in the DCI message may generally applied in the first slot that is at least the configured number of symbols after the last symbol of the PUCCH or PUSCH carrying the HARQ feedback for the TCI state indication. In general, the first slot after the last symbol of the PUCCH or PUSCH and the absolute time duration corresponding to the configured number of symbols may be determined on an active BWP that is included among a set of active BWPs associated with one or more component carriers (or component carrier sets) applying the beam indication associated with the TCI state indication. In some cases, however, the TCI state indication may be applicable to multiple component carriers and/or multiple BWPs that may be associated with different subcarrier spacings, which may lead to variations in the possible duration of the beam application time. For example, because a symbol duration varies depending on the subcarrier spacing (e.g., a larger subcarrier spacing is associated with a shorter symbol duration and vice versa), the absolute time duration corresponding to the beam application time may be determined as Y×S_{duration}, where S_{duration} is the duration of a symbol associated with a subcarrier spacing that is configured for a BWP.

Accordingly, in cases where the TCI state indication may be applicable to multiple component carriers and/or multiple BWPs that may be associated with different subcarrier spacings, the UE may be configured to determine the beam application time (e.g., to identify the first slot that is at least the configured number of symbols after the last symbol of the PUCCH or PUSCH carrying the HARQ feedback for the TCI state indication) based on the active BWP with the smallest subcarrier spacing (e.g., the longest symbol duration) among the active BWPs associated with the component carrier(s) applying the beam indication associated with the TCI state indication. However, in some cases, there may be one or more BWP switches and/or cell changes between the slot when the DCI message carrying the TCI state indication is received and the slot in which the UE transmits the HARQ feedback for the TCI state indication, which can create ambiguity with regard to which component carrier(s) and/or active BWP(s) to use to determine the beam application time. For example, in FIG. 4, a first BWP in a first component carrier set may be active in the slot where the DCI message carrying the TCI state indication is received, a second BWP in a second component carrier set may be active in the slot where the UE transmits the HARQ feedback for the TCI state indication, and a third BWP in a third component carrier set may be active between the slot when the TCI state indication is received and the slot when the HARQ feedback for the TCI state indication is transmitted, where the TCI state indication may be indicated for all three component carriers.

Accordingly, as shown by reference number 440-1, the active BWP that the UE uses to determine the beam application time (e.g., based on the subcarrier spacing of the active BWP) may correspond to an active BWP that has a smallest subcarrier spacing among one or more active BWPs associated with one or more component carriers applying the TCI state indication in the slot where the DCI message carrying the TCI state indication is received (e.g., a BWP with a smallest subcarrier spacing among BWPs included in the first component carrier set). Alternatively, as shown by reference number 440-2, the active BWP that the UE uses to determine the beam application time may correspond to an active BWP that has a smallest subcarrier spacing among one or more active BWPs associated with one or more component carriers applying the TCI state indication in the slot where the UE transmits the HARQ feedback for the TCI state indication (e.g., a BWP with a smallest subcarrier spacing among BWPs included in the second component carrier set). Alternatively, as shown by reference number 440-3, the active BWP that the UE uses to determine the beam application time may correspond to an active BWP that has a smallest subcarrier spacing among one or more active BWPs associated with one or more component carriers applying the TCI state indication between the slot where the DCI message carrying the TCI state indication is received and the slot where the UE transmits the HARQ feedback for the TCI state indication (e.g., a BWP with a smallest subcarrier spacing among BWPs included in any of the first, second, and third component carrier sets).

As further shown in FIG. 4, and by reference number 450, the UE may start to communicate with the network node using the beam associated with the TCI state indication after the beam application time has elapsed. For example, in some aspects, the UE may determine the active BWP that defines the symbol duration for the beam application time using one or more of the techniques described above with respect to reference numbers 440-1, 440-2 and 440-3, and may apply the TCI state indication in the first slot that is least the configured number of symbols after the last symbol of the uplink transmission carrying the HARQ feedback for the TCI state indication. In some aspects, after the TCI state has been applied, the updated beam associated with the TCI state indication may be used for downlink communication, uplink communication, or for downlink and uplink communication between the UE and the network node.

Accordingly, when the UE would transmit the last symbol of a PUCCH with HARQ-ACK information or a PUSCH with HARQ-ACK information corresponding to the DCI carrying the TCI state indication and without a downlink assignment, or corresponding to a PDSCH scheduled by the DCI carrying the TCI state indication, and if the indicated TCI state is different from a previously indicated TCI state, the indicated DLorJointTCIState or UL-TCIstate should be applied starting from a he first slot that is at least BeamAppTime_r17 symbols after the last symbol of the PUCCH or the PUSCH carrying the HARQ-ACK information. In some aspects, the first slot and the BeamAppTime_r17 symbols are both determined on the active BWP with the smallest subcarrier spacing among the active BWP(s) of the carrier(s) applying the beam indication in the slot receiving the TCI state indication.

Additionally, or alternatively, when the UE would transmit the last symbol of a PUCCH with HARQ-ACK information or a PUSCH with HARQ-ACK information corresponding to the DCI carrying the TCI state indication and without a downlink assignment, or corresponding to a PDSCH scheduled by the DCI carrying the TCI state indication, and if the indicated TCI state is different from a previously indicated TCI state, the indicated DLorJointTCIState or UL-TCIstate should be applied starting from a he first slot that is at least BeamAppTime_r17 symbols after the last symbol of the PUCCH or the PUSCH carrying the HARQ-ACK information. In some aspects, the first slot and the BeamAppTime_r17 symbols are both determined on the active BWP with the smallest subcarrier spacing among the active BWP(s) of the carrier(s) applying the beam indication in the slot when the UE transmits the HARQ-ACK information for the TCI state indication. For example, for the beam application time in the unified TCI framework, the active BWP may be determined based on the active BWP with the smallest subcarrier spacing among the active BWP(s) from the applying component carriers at the end of the PUCCH and/or PUSCH transmission(s) carrying the HARQ-ACK for the TCI state indication.

Additionally, or alternatively, when the UE would transmit the last symbol of a PUCCH with HARQ-ACK information or a PUSCH with HARQ-ACK information corresponding to the DCI carrying the TCI state indication and without a downlink assignment, or corresponding to a PDSCH scheduled by the DCI carrying the TCI state indication, and if the indicated TCI state is different from a previously indicated TCI state, the indicated DLorJointTCIState or UL-TCIstate should be applied starting from a he first slot that is at least BeamAppTime_r17 symbols after the last symbol of the PUCCH or the PUSCH carrying the HARQ-ACK information. In some aspects, the first slot and the BeamAppTime_r17 symbols are both determined on the active BWP with the smallest subcarrier spacing among the active BWP(s) of the carrier(s) applying the beam indication between the slot receiving the TCI state indication and the slot when the UE transmits the HARQ-ACK information for the TCI state indication.

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 120) performs operations associated with an active BWP for beam application time in unified TCI framework.

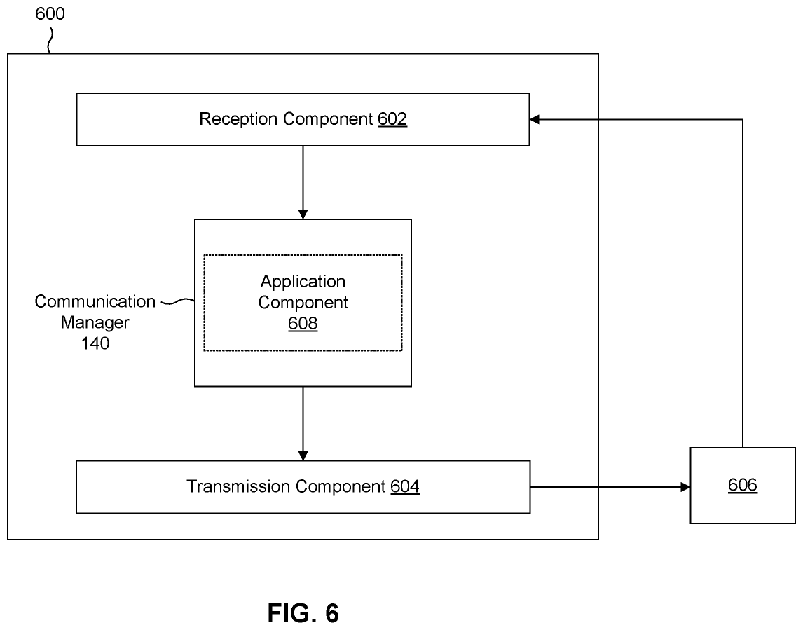

As shown in FIG. 5, in some aspects, process 500 may include receiving, from a network node, a DCI message that carries a TCI state indication (block 510). For example, the UE (e.g., using communication manager 140 and/or reception component 602, depicted in FIG. 6) may receive, from a network node, a DCI message that carries a TCI state indication, as described above.

As further shown in FIG. 5, in some aspects, process 500 may include applying the TCI state indication after a beam application time that is based at least in part on an active bandwidth part associated with the TCI state indication (block 520). For example, the UE (e.g., using communication manager 140 and/or application component 608, depicted in FIG. 6) may apply the TCI state indication after a beam application time that is based at least in part on an active bandwidth part associated with the TCI state indication, as described above.

As further shown in FIG. 5, in some aspects, process 500 may include communicating with the network node using a beam associated with the TCI state indication after the TCI state indication is applied (block 530). For example, the UE (e.g., using communication manager 140, reception component 602, and/or transmission component 604, depicted in FIG. 6) may communicate with the network node using a beam associated with the TCI state indication after the TCI state indication is applied, as described above.

Process 500 may include additional aspects, such as any single aspect or any combination of aspects described below and/or in connection with one or more other processes described elsewhere herein.

In a first aspect, the active BWP associated with the beam application time is an active BWP with a smallest subcarrier spacing among a set of active BWPs in a set of component carriers applying a beam associated with the TCI state indication in a slot in which the DCI message is received.

In a second aspect, alone or in combination with the first aspect, the active BWP associated with the beam application time is an active BWP with a smallest subcarrier spacing among a set of active BWPs in a set of component carriers applying a beam associated with the TCI state indication in a slot carrying HARQ feedback for the TCI state indication.

In a third aspect, alone or in combination with one or more of the first and second aspects, the active BWP associated with the beam application time is an active BWP with a smallest subcarrier spacing among a set of active BWPs in a set of component carriers applying a beam associated with the TCI state indication between a first slot in which the DCI message is received and a second slot carrying HARQ feedback for the TCI state indication.

In a fourth aspect, alone or in combination with one or more of the first through third aspects, the beam application time is based at least in part on a configured number of symbols and a subcarrier spacing associated with the active BWP.

In a fifth aspect, alone or in combination with one or more of the first through fourth aspects, the TCI state indication is applied starting from a first slot that is at least the configured number of symbols after a last symbol of an uplink transmission that carries HARQ feedback for the DCI message carrying the TCI state indication or a physical downlink shared channel transmission scheduled by the DCI message carrying the TCI state indication.

In a sixth aspect, alone or in combination with one or more of the first through fifth aspects, the uplink transmission is a physical uplink control channel transmission that carries the HARQ feedback.

In a seventh aspect, alone or in combination with one or more of the first through sixth aspects, the uplink transmission is a physical uplink shared channel transmission that carries the HARQ feedback.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication, in accordance with the present disclosure. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include the communication manager 140. The communication manager 140 may include an application component 608, among other examples.

In some aspects, the apparatus 600 may be configured to perform one or more operations described herein in connection with FIG. 4. Additionally, or alternatively, the apparatus 600 may be configured to perform one or more processes described herein, such as process 500 of FIG. 5. In some aspects, the apparatus 600 and/or one or more components shown in FIG. 6 may include one or more components of the UE described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, a modem, a demodulator, a MIMO detector, a receive processor, a controller/processor, a memory, or a combination thereof, of the UE described in connection with FIG. 2.

The transmission component 604 may transmit communications, such as reference signals, control information, data communications, or a combination thereof, to the apparatus 606. In some aspects, one or more other components of the apparatus 600 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modem, a modulator, a transmit MIMO processor, a transmit processor, a controller/processor, a memory, or a combination thereof, of the UE described in connection with FIG. 2. In some aspects, the transmission component 604 may be co-located with the reception component 602 in a transceiver.

The reception component 602 may receive, from a network node, a DCI message that carries a TCI state indication. The application component 608 may apply the TCI state indication after a beam application time that is based at least in part on an active BWP associated with the TCI state indication. The reception component 602 and/or the transmission component 604 may communicate with the network node using a beam associated with the TCI state indication after the TCI state indication is applied.

The number and arrangement of components shown in FIG. 6 are provided as an example. In practice, there may be additional components, fewer components, different components, or differently arranged components than those shown in FIG. 6.

Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some Aspects of the present disclosure:

Aspect 1: A method of wireless communication performed by a UE, comprising: receiving, from a network node, a DCI message that carries a TCI state indication; applying the TCI state indication after a beam application time that is based at least in part on an active BWP associated with the TCI state indication; and communicating with the network node using a beam associated with the TCI state indication after the TCI state indication is applied.

Aspect 2: The method of Aspect 1, wherein the active BWP associated with the beam application time is an active BWP with a smallest subcarrier spacing among a set of active BWPs in a set of component carriers applying a beam associated with the TCI state indication in a slot in which the DCI message is received.

Aspect 3: The method of Aspect 1, wherein the active BWP associated with the beam application time is an active BWP with a smallest subcarrier spacing among a set of active BWPs in a set of component carriers applying a beam associated with the TCI state indication in a slot carrying HARQ feedback for the TCI state indication.

Aspect 4: The method of Aspect 1, wherein the active BWP associated with the beam application time is an active BWP with a smallest subcarrier spacing among a set of active BWPs in a set of component carriers applying a beam associated with the TCI state indication between a first slot in which the DCI message is received and a second slot carrying HARQ feedback for the TCI state indication.

Aspect 5: The method of any of Aspects 1-4, wherein the beam application time is based at least in part on a configured number of symbols and a subcarrier spacing associated with the active BWP.

Aspect 6: The method of Aspect 5, wherein the TCI state indication is applied starting from a first slot that is at least the configured number of symbols after a last symbol of an uplink transmission that carries HARQ feedback for the DCI message carrying the TCI state indication or a physical downlink shared channel transmission scheduled by the DCI message carrying the TCI state indication.

Aspect 7: The method of Aspect 6, wherein the uplink transmission is a PUCCH transmission that carries the HARQ feedback.

Aspect 8: The method of Aspect 6, wherein the uplink transmission is a PUSCH transmission that carries the HARQ feedback.

Aspect 9: An apparatus for wireless communication at a device, comprising a processor; memory coupled with the processor; and instructions stored in the memory and executable by the processor to cause the apparatus to perform the method of one or more of Aspects 1-8.

Aspect 10: A device for wireless communication, comprising a memory and one or more processors coupled to the memory, the one or more processors configured to perform the method of one or more of Aspects 1-8.

Aspect 11: An apparatus for wireless communication, comprising at least one means for performing the method of one or more of Aspects 1-8.

Aspect 12: A non-transitory computer-readable medium storing code for wireless communication, the code comprising instructions executable by a processor to perform the method of one or more of Aspects 1-8.

Aspect 13: A non-transitory computer-readable medium storing a set of instructions for wireless communication, the set of instructions comprising one or more instructions that, when executed by one or more processors of a device, cause the device to perform the method of one or more of Aspects 1-8.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a +a+c, a+b+b, a+c+c, b+b, b+b+b, b+b+c, c+c, andc+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive, from a network node, a downlink control information (DCI) message that carries a transmission configuration indication (TCI) state indication;
apply the TCI state indication after a beam application time that is based at least in part on an active bandwidth part associated with the TCI state indication; and
communicate with the network node using a beam associated with the TCI state indication after the TCI state indication is applied.

2. The UE of claim 1, wherein the active bandwidth part associated with the beam application time is an active bandwidth part with a smallest subcarrier spacing among a set of active bandwidth parts in a set of component carriers applying a beam associated with the TCI state indication in a slot in which the DCI message is received.

3. The UE of claim 1, wherein the active bandwidth part associated with the beam application time is an active bandwidth part with a smallest subcarrier spacing among a set of active bandwidth parts in a set of component carriers applying a beam associated with the TCI state indication in a slot carrying hybrid automatic repeat request feedback for the TCI state indication.

4. The UE of claim 1, wherein the active bandwidth part associated with the beam application time is an active bandwidth part with a smallest subcarrier spacing among a set of active bandwidth parts in a set of component carriers applying a beam associated with the TCI state indication between a first slot in which the DCI message is received and a second slot carrying hybrid automatic repeat request feedback for the TCI state indication.

5. The UE of claim 1, wherein the beam application time is based at least in part on a configured number of symbols and a subcarrier spacing associated with the active bandwidth part.

6. The UE of claim 5, wherein the TCI state indication is applied starting from a first slot that is at least the configured number of symbols after a last symbol of an uplink transmission that carries hybrid automatic repeat request (HARQ) feedback for the DCI message carrying the TCI state indication or a physical downlink shared channel transmission scheduled by the DCI message carrying the TCI state indication.

7. The UE of claim 6, wherein the uplink transmission is a physical uplink control channel transmission that carries the HARQ feedback.

8. The UE of claim 6, wherein the uplink transmission is a physical uplink shared channel transmission that carries the HARQ feedback.

9. A method of wireless communication performed by a user equipment (UE), comprising:
receiving, from a network node, a downlink control information (DCI) message that carries a transmission configuration indication (TCI) state indication;
applying the TCI state indication after a beam application time that is based at least in part on an active bandwidth part associated with the TCI state indication; and
communicating with the network node using a beam associated with the TCI state indication after the TCI state indication is applied.

10. The method of claim 9, wherein the active bandwidth part associated with the beam application time is an active bandwidth part with a smallest subcarrier spacing among a set of active bandwidth parts in a set of component carriers applying a beam associated with the TCI state indication in a slot in which the DCI message is received.

11. The method of claim 9, wherein the active bandwidth part associated with the beam application time is an active bandwidth part with a smallest subcarrier spacing among a set of active bandwidth parts in a set of component carriers applying a beam associated with the TCI state indication in a slot carrying hybrid automatic repeat request feedback for the TCI state indication.

12. The method of claim 9, wherein the active bandwidth part associated with the beam application time is an active bandwidth part with a smallest subcarrier spacing among a set of active bandwidth parts in a set of component carriers applying a beam associated with the TCI state indication between a first slot in which the DCI message is received and a second slot carrying hybrid automatic repeat request feedback for the TCI state indication.

13. The method of claim 9, wherein the beam application time is based at least in part on a configured number of symbols and a subcarrier spacing associated with the active bandwidth part.

14. The method of claim 13, wherein the TCI state indication is applied starting from a first slot that is at least the configured number of symbols after a last symbol of an uplink transmission that carries hybrid automatic repeat request (HARQ) feedback for the DCI message carrying the TCI state indication or a physical downlink shared channel transmission scheduled by the DCI message carrying the TCI state indication.

15. The method of claim 14, wherein the uplink transmission is a physical uplink control channel transmission that carries the HARQ feedback.

16. The method of claim 14, wherein the uplink transmission is a physical uplink shared channel transmission that carries the HARQ feedback.

17. A non-transitory computer-readable medium storing a set of instructions for wireless communication, the set of instructions comprising:
one or more instructions that, when executed by one or more processors of a user equipment (UE), cause the UE to:
receive, from a network node, a downlink control information (DCI) message that carries a transmission configuration indication (TCI) state indication;
apply the TCI state indication after a beam application time that is based at least in part on an active bandwidth part associated with the TCI state indication; and
communicate with the network node using a beam associated with the TCI state indication after the TCI state indication is applied.

18. The non-transitory computer-readable medium of claim 17, wherein the active bandwidth part associated with the beam application time is an active bandwidth part with a smallest subcarrier spacing among a set of active bandwidth parts in a set of component carriers applying a beam associated with the TCI state indication in a slot in which the DCI message is received.

19. The non-transitory computer-readable medium of claim 17, wherein the active bandwidth part associated with the beam application time is an active bandwidth part with a smallest subcarrier spacing among a set of active bandwidth parts in a set of component carriers applying a beam associated with the TCI state indication in a slot carrying hybrid automatic repeat request feedback for the TCI state indication.

20. The non-transitory computer-readable medium of claim 17, wherein the active bandwidth part associated with the beam application time is an active bandwidth part with a smallest subcarrier spacing among a set of active bandwidth parts in a set of component carriers applying a beam associated with the TCI state indication between a first slot in which the DCI message is received and a second slot carrying hybrid automatic repeat request feedback for the TCI state indication.

21-32. (canceled)
